(19) United States
(12) Patent Application Publication
(10) Pub. No.: US 2006/0047766 A1
(43) Pub. Date: Mar. 2, 2006

(54) Controlling transmission of email

(75) Inventor: Joseph R. Spadea III, Canton, MA (US)

Correspondence Address: ROBERT PLOTKIN, PC, 91 MAIN STREET, SUITE 204, CONCORD, MA, 01742-2527, US

(73) Assignee: SquareAnswer, Inc.

(21) Appl. No.: 11/206,625

(22) Filed: Aug. 18, 2005

Related U.S. Application Data
(60) Provisional application No. 60/605,430, filed on Aug. 30, 2004.

(51) Int. Cl. G06F 15/16

(52) U.S. Cl. 709/206

(57) ABSTRACT

Techniques are disclosed for controlling the transmission of undesired bulk email by, for example, authenticating and classifying sender email addresses and aggregating recipient feedback to provide to participating senders. For example, senders may be separated into two classes—real people and bulk emailers. Senders may be authenticated in different ways depending on their classes. For example, a real person may be authenticated based on its email address and an identifying key, while a bulk emailer may be authenticated based on its email address, an identifying key, and its IP address. Similarly, feedback received from recipients may be provided differently to senders depending on their classes. For example, negative feedback about real people may be provided by limiting such people to sending a certain number of emails per day, while negative feedback about bulk emailers may be provided by charging such emailers a fee.

### CROSS REFERENCE TO RELATED APPLICATIONS

This application claims priority from U.S. Provisional Patent Application Ser. No. 60/605,430, filed on Aug. 30, 2004, entitled “System and Method to Move the Costs of. Unsolicited Bulk Email from the Recipient to the Sender by Providing a Feedback Loop,” which is hereby incorporated by reference.

### BACKGROUND

1. Field of the Invention

The present invention relates to electronic communications and, more particularly, to techniques for controlling the transmission of email.

2. Related Art

Email has become one of the most widely-used and valuable forms of communication. The popularity of email stems in part from its simplicity (even novice users can quickly learn how to send and receive email), its low bandwidth requirements (making it usable even over low-bandwidth connections such as those available in many homes and on many wireless networks), and its asynchronicity (which allows participants in an email exchange to read and write messages at their convenience). Email use has become hampered, however, by various forms of email that generally are referred to as “spam.” The word “spam” refers both to an undesired bulk email itself and to the act of transmitting such email (“spamming”).

It is common for computer users to find hundreds of spam email messages in their email inboxes at the beginning of a day. Such messages create a variety of problems. For example, the sheer volume of spam may make browsing through an inbox an extremely time-consuming process. Furthermore, solicited or otherwise welcome emails that the recipient desires to read may become visually buried among the clutter of spam, thereby increasing the likelihood that the recipient will overlook or even delete such welcome messages in the course of deleting spam.

The sheer volume of spam may consume a considerable amount of the individual user's network bandwidth, which may significantly increase the time required for the user to check for new email. The bandwidth burden that spam imposes on an Internet Service Provider (ISP) is a multiple of the number of the ISP's users. As a result, ISPs incur significant costs transmitting spam that is only to be deleted once it lands in the recipient's inbox.

Moreover, spam often advertises products that are offensive (such as pornography) or inappropriate for children or other audiences (such as libido-enhancing drugs). Because “spammers” typically broadcast spam indiscriminately to as many email addresses as they can obtain, it is extremely difficult to stop such spam from reaching one's inbox, or the inboxes of one's children, if one wishes to avoid offensive or inappropriate material.

Spam is harmful not only because it wastes resources, but because the content of the spam itself may be harmful. Spam often includes viruses and other computer code that is capable of installing itself on the recipient's computer and performing harmful actions, such as destroying data, copying private information and transmitting it over the Internet to a third party, and using the recipient's computer to invisibly send additional spam to others. Such malicious computer code can be difficult to detect and remove, particularly for novice computer users.

Furthermore, spam is often used to perpetrate fraudulent activities. For example, many spam messages describe false stories of a person in need or an opportunity for financial gain, and conclude by requesting that the recipient provide money or bank account information. Those who respond to such messages often become victims of a scam and suffer real financial harm as a result.

The increasingly common practice of “phishing” involves sending messages to customers of a business, such as a bank, that appear to be official messages sent by the business. Such messages typically ask the recipient to provide critical private financial information, such as credit card numbers and passwords. Successful phishing attacks not only defraud innocent individuals of their money and invade their privacy, they also cause serious harm to the reputation of the impersonated business. The resulting lack of trust is making it increasingly difficult for legitimate businesses to communicate with their customers over the Internet.

Spammers often use sophisticated techniques to forge their email addresses and otherwise hide their identities, making them difficult to track down. As a result, it has proven difficult to use legal mechanisms, such as civil lawsuits and criminal prosecutions, against spammers. Furthermore, spam may be sent from anywhere in the world to anywhere in the world, making the law effectively unenforceable in many cases due to cross-border jurisdictional problems and other complexities of international law enforcement.

In the U.S., the CAN-SPAM Act of 2003 imposes certain restrictions on the transmission of unsolicited commercial email. This statute, however, falls far short of the kind of protection against spam that many users desire. The Act, for example, does not expressly prohibit transmission of unsolicited commercial email. Rather, the Act essentially requires those who transmit such messages to provide a mechanism for the messages' recipients to opt out of receiving future email from the same sender. Many users would prefer the ability to go further than this by preventing spam from ever reaching their inboxes.

In response to the many spam-related problems described above, many technical systems for controlling spam have been developed. The most common kind of system is software that attempts to identify incoming spam, either at the email server (e.g., at an ISP) or at the email client (e.g., at the computer user's computer). If the anti-spam software identifies an incoming email as spam, the software takes an appropriate action, such as deleting the email or marking it as spam.

The essential problem faced by such software is how to distinguish legitimate email from spam as accurately as possible. “Accuracy” can be measured in terms of true positives (spam that is correctly identified as spam), false positives (legitimate email that is incorrectly identified as spam), true negatives (legitimate email that is correctly identified as legitimate), and false negatives (spam that is incorrectly identified as legitimate). The perfect system would produce only true positives and true negatives. Of particular concern to most users are false positives, because incorrectly labeling a legitimate email as spam may prevent and/or delay receipt of a legitimate, and possibly important and urgent, email message.

Existing anti-spam systems attempt to approximate this ideal in a variety of ways. Many systems, for example, analyze the text in incoming email to determine whether the text includes any telltale indicators of spam, such as the words “free” or “sex,” the use of all capital letters (e.g., “BEST PRICES”), or the use of exclamation points (e.g., “!!!!!Biotech Stocks at All-Time Lows!!!!!!!”). Many systems also inspect information about the sender, such as the sender's email address and/or IP address, in an attempt to determine-whether the sender is a known or likely spammer.

Other systems rely on “blacklists” of abusive IP addresses. A blacklist lists IP addresses from which email is prohibited. The use of blacklists encourages spammers to change their IP addresses often—sometimes every 5 minutes—thereby effectively evading the protection intended by the system.

Other systems utilize a “challenge/response” protocol in which the sender is challenged to provide information proving that it is a person before the sender is allowed to send email to a specific recipient. One problem with such systems is that they challenge even legitimate senders of bulk email, thereby making auto-responses such as receipts and confirmations impossible to transmit without the recipient performing additional steps.

Some systems utilize “collaborative filtering” to block email that is rejected by a large number of recipients. One problem with such systems is that they encourage spammers to invent sender email addresses, to frequently change IP addresses, or both.

The fundamental problem with these approaches is that they inevitably produce false positives and false negatives. A friend who sends an excited email message with the subject line “HAPPY BIRTHDAY!!!” may find such an email labeled as spam, while an advertisement for “Mortgage rates worth considering” may slip-past a text-based spam filter.

Furthermore, once the spam filtering rules used by such systems become known to spammers, the spammers inevitably modify their spam to evade detection by the rules. A rule that searches for the word “pornography” will not detect either “pornography” (with the letter “o” replaced by zeros) or “p.o.r.n.o.g.r.a.p.h.y.” Although the spam filtering rules may be updated in response to these tactics, this inevitably produces an “arms race” in which the spammers stay one step ahead of the anti-spam filters. Even if anti-spam software writers could keep closely behind spammers, repeated broadening of the anti-spam filter rules runs the risk of creating rules with so many exceptions that they swallow the rules and produce an unacceptably high rate of false positives. Furthermore, anti-spam rules promote bad behavior, such as encouraging spammers to invent sender email addresses, to frequently change IP addresses, or both.

What is needed, therefore, are improved techniques for controlling the transmission of bulk email.

### SUMMARY

Techniques are disclosed for controlling the transmission of undesired bulk email by, for example, authenticating and classifying sender email addresses and aggregating recipient feedback to provide to participating senders. For example, senders may be separated into two classes—real people and bulk emailers. Senders may be authenticated in different ways depending on their classes. For example, a real person may be authenticated based on its email address and an identifying key, while a bulk emailer may be authenticated based on its email address, an identifying key, and its IP address. Similarly, feedback received from recipients may be provided differently to senders depending on their classes. For example, negative feedback about real people may be provided by limiting such people to sending a certain number of emails per day, while negative feedback about bulk emailers may be provided by charging such emailers a fee.

In one embodiment, a system is provided that requires a would-be sender of an email message to provide input that satisfies predetermined conditions indicating that the sender is a person. The input may, for example, be provided in the form of an answer to a question posed to the sender by the system. If the sender is unable to provide such input, subsequent email messages transmitted by the sender are rejected by the system. If the sender is able to provide such input, an email address of the sender is added to a set of verified email senders. If the sender is verified, subsequent email messages transmitted by the sender may be transmitted to their recipients.

In another embodiment, a computer-implemented method is provided that includes: (A) attempting to extract from an email message a sender email address and a key associated with the sender email address; and (B) transmitting the email message to a specified recipient of the email message only if the sender email address and key are successfully extracted and the sender email address and key are associated with an email sender.

In yet another embodiment, a computer-implemented method is provided that includes comprising: (A) determining whether a sender email address is a verified sender email address; (B) determining whether a key is associated with the verified sender email address; and (C) providing over a network an indication whether the sender email address is a verified sender email address and whether the key is associated with the verified sender email address.

In a further embodiment, a method is provided that includes: (A) identifying a plurality of email senders as verified and desired email senders; (B) identifying a plurality of email servers as member email servers, the plurality of email servers having a plurality of email users; and (C)

In still a further embodiment, a computer-implemented method is provided that includes: (A) providing in an email message a tag specifying whether the email message is of a first class that requires the transmission of a Non-Delivery Report (NDR) upon failure to transmit the email message to its recipient or of a second class that does not require the transmission of an NDR upon failure to transmit the email message to its recipient; and (B) transmitting the email message over a network.

In another embodiment, a computer-implemented method is provided that includes: (A) receiving an email message containing a tag specifying whether the email message is of a first class that requires the transmission of a Non-Delivery Report (NDR) upon failure to transmit the email message to its recipient or of a second class that does not require the transmission of an NDR upon failure to transmit the email message to its recipient; (B) determining whether the email message has failed to be transmitted to its recipient; and (C) if the email message is determined to have failed to be transmitted to its recipient: (C)(1) identifying the class specified by the tag; and (C)(2) transmitting an NDR only if the specified class is the first class.

In still another embodiment, a computer-implemented method is provided that includes: (A) receiving an email from a sender over a computer network; (B) receiving feedback about the email from a designated recipient of the email; (C) determining whether the sender is a bulk sender of email; (D) if the sender is a bulk sender, processing the feedback using a first method; and (E) if the sender is not a bulk sender, processing the feedback using a second method that differs from the first method.

In another embodiment, a computer-implemented method is provided that includes: (A) receiving a first email over a computer network, the first email specifying a sender email address; (B) in response to receiving the first email, sending a message to the sender email address; (C) determining whether the message is deliverable to the sender email address; (D) identifying an intended recipient of the first email; and (E) providing the intended recipient of the first email an indication whether the message is deliverable.

Other features and advantages of various aspects and embodiments of the present invention will become apparent from the following description and from the claims.

### BRIEF DESCRIPTION OF THE DRAWINGS

FIG. 1 is a dataflow diagram of a system that is used to implement a database of verified email senders according to one embodiment of the present invention;

FIG. 2 is a flowchart of a method that is performed by the system of FIG. 1 in one embodiment of the present invention when a potential sender of email attempts to register its email address in the verified sender database;

FIG. 3 is a dataflow diagram of a system that is used to filter email according to one embodiment of the present invention;

FIG. 4A is a flowchart of a method that is performed by the system of FIG. 3 in one embodiment of the present invention when a sender of email attempts to transmit an email message;

FIG. 4B is a flowchart of a method illustrating steps that are performed when an unknown sender of email attempts to send an email according to one embodiment of the present invention;

FIG. 4C is a flowchart of a method that is performed by the system of FIG. 3 in another embodiment of the present invention when a sender of email attempts to transmit an email message;

FIG. 4D is a flowchart of a method that is performed by the system of FIG. 3 in one embodiment of the present invention to process different classes of email differently according to one embodiment of the present invention;

FIG. 5 is a dataflow diagram of a system that is used to provide a guarantee that email sent by a sender will not be identified by certain email servers as undesired email according to one embodiment of the present invention; and

FIG. 6 is a flowchart of a method that is performed by the system of FIG. 5 according to one embodiment of the present invention.

### DETAILED DESCRIPTION

Most, if not all, of the difficulty in controlling spam from an engineering standpoint stems from the fact that the system for transmitting email—Simple Mail Transfer Protocol (SMTP)—was designed with a faulty feedback loop. When an SMTP server is unable to deliver an email message (because, for example, the destination email address is invalid), it sends a Non-Delivery Report (NDR) to the sender of the email. Because the business model of spammers is based on keeping their cost per email transmitted as low as possible, they may send spam to millions of email addresses, many thousands of which may be invalid or otherwise unreachable. If the spammer had to receive an NDR for each such invalid email, the cost to the spammer would rise significantly and thereby threaten the viability of the spammer's business model.

As a result, spammers often fabricate their email addresses to avoid receiving the NDRs that are sent to them. The SMTP protocol, however, provides no mechanism for ensuring that the sender of an email be able to receive NDRs. Spammers, therefore, are able to continue sending high volumes of email containing large numbers of undeliverable emails, without receiving negative feedback in the form of increased cost to them. The existing system therefore provides a perverse incentive to spammers to fabricate bogus sender addresses.

Furthermore, the undeliverable emails sent by spammers impose a significant cost on email servers because according to the SMTP protocol an email server typically attempts to send out each NDR a reasonable number of times, such as every 15 minutes for 7 days.

There is, in summary, very little gain in the email cost feedback loop, and the gain is continually decreasing as improving technology lowers the cost of sending each email. In contrast, the cost of sending postal mail (“snail mail”) provides sufficient negative feedback to senders—in the form of the high cost of mailing—to drive senders to prepare their mailing campaigns carefully, such as by targeting specific audiences that are likely to be willing recipients of the sender's message.

The very characteristics of SMTP that make spam profitable—the ability to send email inexpensively and anonymously—were originally designed into SMTP as features, not bugs. But SMTP was developed before the Internet was used for commercial purposes and long before the advent of spam. SMTP, in short, was not designed to take into account the possibility that users would take advantage of low cost and anonymous email for malicious purposes.

In general, embodiments of the invention disclosed herein reduce or even eliminate the incentive to fabricate bogus email sender addresses, provide mechanisms for preventing the unauthorized use of real email addresses, and increase the feedback loop gain for those emails that are undeliverable and/or undesired by the recipient. As a result, the techniques disclosed herein may be used to effectively combat spam and other forms of illegitimate email by addressing the fundamental problems with SMTP described above.

In one embodiment of the present invention, the problem of differentiating between legitimate and illegitimate emails is addressed by creating a database of email addresses that are believed to correspond to real people and email addresses corresponding to participating bulk emailers. As will be described in more detail below, once such a database exists, it may be used by email servers to filter out email that is transmitted by non-participating bulk senders and therefore likely to constitute spam. More generally, the database of verified sender addresses may be used to distinguish between those emails that are likely to be desired by their recipients and those emails that are likely to be undesired by their recipients.

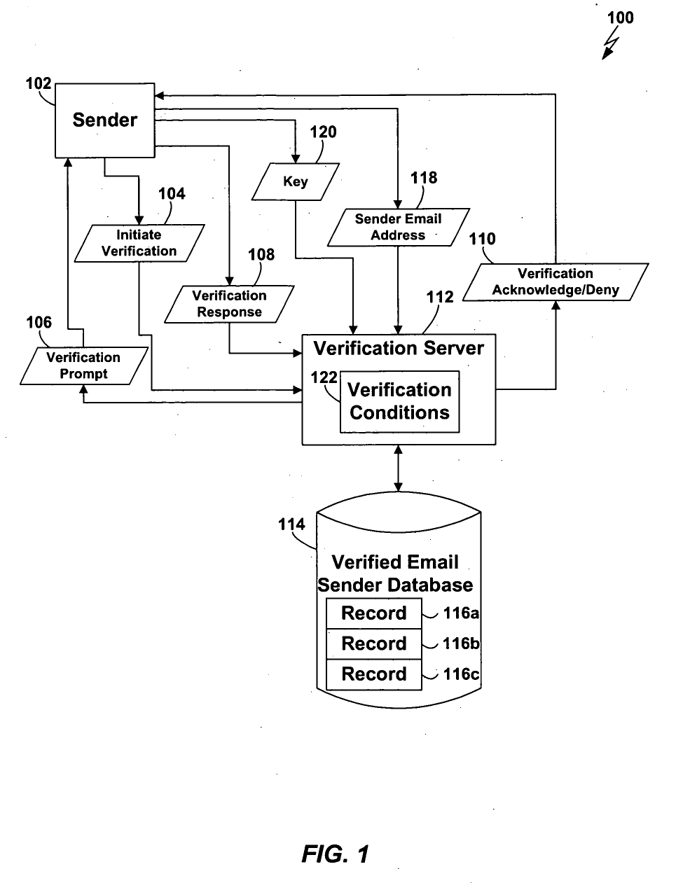

Referring to FIG. 1, a dataflow diagram is shown of a system 100 that is used to implement such an email address database according to one embodiment of the present invention. Note that although elements of the system 100 are illustrated abstractly, those having ordinary skill in the art will appreciate how to implement the elements of FIG. 1 using appropriate hardware, software, and other technology based on the description provided herein.

The system 100 includes a database 114 or other registry containing records 116a-c indicating email addresses that have been verified (with a sufficient degree of confidence) to correspond to real people. Although only three records 116a-c are shown in FIG. 1 for purposes of example, the database 114 may include any number of records, and in practice may include millions or more records. Each of the records 116a-c specifies a verified sender email address and optionally other information about the corresponding sender, as will be described in more detail below. A verification server 112 acts as an interface between the database 114 and other elements of the system 100.

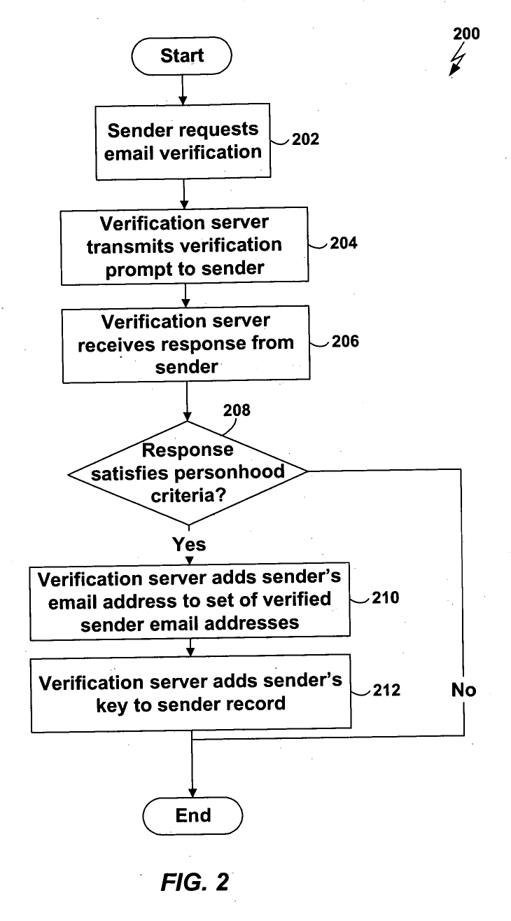

Referring to FIG. 2, a flowchart is shown of a method 200 that is performed by the system 100 of FIG. 1 when a potential sender 102 of email attempts to register its email address in the verified sender database 114. Note that the sender 102 may or may not be a person. For example, the sender 102 may be a software program for sending bulk commercial email. In ways that will now be described, the method 200 attempts to determine whether the sender 102 is a person, and only adds the email address of the sender 102 to the database 114 if the sender 102 satisfies predetermined conditions 122 indicating that the sender 102 is a person.

The sender 102 transmits a message 104 to the server 112 requesting that verification of the sender's email address begin (step 202). Note that the message 104, and other messages illustrated in FIG. 2, may be transmitted over any kind of network using any kind of network protocol. For example, the message 104 may be transmitted over a wired or wireless network using TCP/IP.

As will be described in more detail below, the sender 102 may transmit the verification initiation message 104 after the sender 102 attempts to transmit an email message to a recipient who requires that sender email addresses be verified. Alternatively, the sender 102 may transmit the message 104 without first attempting to send any email to such a recipient. The sender 102 may, for example, be aware that one or more desired recipients require that senders use verified email addresses, and may wish to proactively register its email address in the database 114. At this point in the process, therefore, the sender 102 may be a potential, rather than an actual, sender of email.

The verification server 112 receives the verification initiation message 104 and, in response, transmits a verification prompt 106 to the sender 102 (step 204). The prompt 106 prompts the sender 102 to provide information that is likely to distinguish real people from other kinds of senders. The prompt 106, therefore, is formulated with the intent that it be easy for humans and difficult for machines to respond to the prompt 106. The term “captcha” has come to be used for this class of prompts, and several kinds of captchas are well-known. For example, one kind of captcha displays a word that has been visually distorted in such a way that it is still relatively easy for a human reader to recognize, but such that it is relatively difficult or impossible for optical character recognition and other software to recognize.

The prompt 106 may be this kind or any other kind of captcha. More generally, the prompt 106 need not be a captcha, but more generally may be any prompt that is expected to be relatively easy for a typical human to respond to and relatively difficult for a typical machine to respond to. The prompt 106 may include graphics, text, sound, or any other kind of content in any combination.

One reason for using the prompt 106 is that it imposes costs on those senders attempting to use automated systems for sending bulk email by requiring the sender to employ a human to respond to the prompt 106. Costs, however, may be imposed on such senders in other ways. For example, in addition to or instead of providing a prompt that is difficult for a machine to respond to, the prompt 106 may impose a delay that requires the sender 102 to wait some amount of time before providing a response to the prompt 106. The delay, may, for example, be of a fixed or variable duration. For example, the delay may require the sender 102 to wait for 2 seconds before providing a response. Alternatively, for example, the prompt 106 may begin displaying images and ask the sender 102 to hit a key when an image of a rabbit appears. Imposing this delay on senders imposes a trivial cost on real people but can impose a significant cost on bulk emailers wishing to send thousands or millions of email messages.

The server 112 may select the prompt 106 to transmit to the sender 102 in any of a variety of ways. For example, the server 112 may select the prompt 106, randomly or otherwise, from a predetermined set of prompts. Alternatively, for example, the server 112 may generate the prompt 106 on the fly using any kind of generation procedure. For example, the server 112 may generate a captcha by: (1) selecting a word from a predetermined set of words; (2) selecting a distortion procedure from a predetermined set of distortion procedures; and (3) applying the selected distortion procedure to the selected word to produce the captcha. This is merely an example and does not constitute a limitation of the present invention.

The sender 102 transmits to the server 112 a response 108 to the prompt 106 (step 206). The response 108 may take any appropriate form and may be transmitted by the sender 102 in any appropriate manner. For example, if the prompt 106 is a captcha that displays a distorted word, the response 108 may be text that the sender 102 submits as its estimate of the word. The response 108 may include text, graphics, sound, biometrics, movement, or any other kinds of input provided in any manner.

The server 112 determines whether the response 108 satisfies predetermined conditions 122 indicating that the sender 102 is a real person (step 208). The server 112 may be preprogrammed with such conditions 122 in the form of rules, algorithms, or any other kind of decision procedure. If, for example, the prompt 106 is a captcha that displays a distorted word, the predetermined conditions 122 may simply represent the word itself. In such a case, the server 112 determines that the response 108 satisfies the predetermined conditions 122 if the response 108 is the correct word.

Note, however, that the predetermined conditions 122 need not specify a single fixed answer for each possible prompt. Rather, for example, multiple responses may satisfy the predetermined conditions 122. Furthermore, the predetermined conditions 122 may embody fuzzy rather than deterministic matching procedures. All of these are merely examples since, as mentioned above, embodiments of the present invention are not limited to using any particular kind of predetermined conditions.

If the received response 108 to the prompt 106 satisfies the predetermined conditions 122, the verification server 112 adds an email address 118 of the sender 102 to the database 114 of verified email addresses (step 210). The email address 118 may be stored in one of the corresponding records 116a-c in the database 114. If the received response 108 does not satisfy the predetermined conditions 122, the verification server 112 either does not add the sender's email address 118 to the database 114 or adds the sender's email address 118 to the database 114 and indicates that the email address 118 is disabled (not verified).

The server 112 may obtain the email address 118 of the sender 102 in any of a variety of ways. For example, the sender 102 may transmit the email address 118 directly to the server 112. The sender 102 may, for example, type the email address 118 in a web-based form and submit the email address 118 to the server 112. Alternatively, for example, and as will be described in more detail below, the server 112 may extract the email address 118 from an email sent by the sender 102.

During the process of registering with the verified sender database 114, the sender 102 may select or otherwise be provided with an identifying key 120 that preferably is unique to the sender 102. If the sender 102 is verified, the verification server 112 adds the sender's key 120 to the database 114 (step 212). The sender 102 may be provided with the ability to request a key change to prevent suspected fraud or otherwise prevent hijacking of the sender's email address 118.

Each of the records 116a-c in the database 114 may correspond to a particular sender and may store both the email address and key for that sender. Assuming for purposes of example that record.116a corresponds to sender 102, the record 116a may include both the sender's email address 118 and key 120. The purpose of the key 120 is to provide additional, relatively non-public, information identifying the sender 102 that may be used to verify that emails which purport to be transmitted by the sender 102 are actually being transmitted by the sender 102 and not by someone else. Examples of ways in which the key 120 may be used will be described in more detail below.

The key 120 may be generated in any way. For example, the sender 102 may select the key 120 and provide it to the server 112, such as typing a sequence of characters representing the key 120. The sender 102 may transmit the selected key 120 for storage in the corresponding record of the database 114. Alternatively, the server 112 may generate a key 120 for the sender 102 and provide the generated key 120 to the sender 102. These are merely examples of techniques that may be used to generate the key 120 and do not constitute limitations of the present invention.

The key 120 may take any form. For example, as just mentioned, the key 120 may be a text string. Alternatively, for example, the key 120 may include text, graphics, sound, biometrics, or any other kinds of information in any combination. These are merely examples and do not constitute limitations of the present invention.

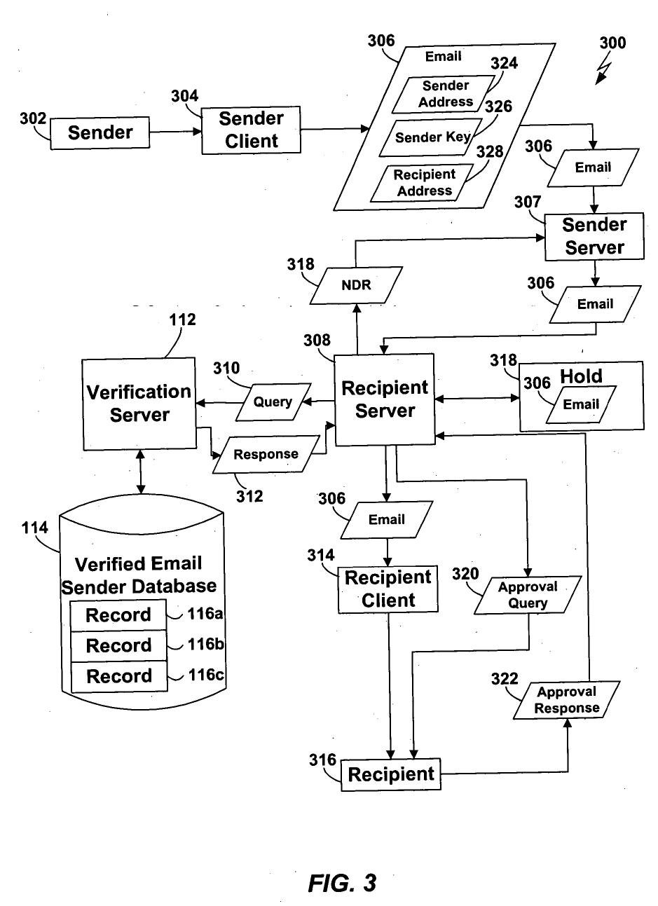

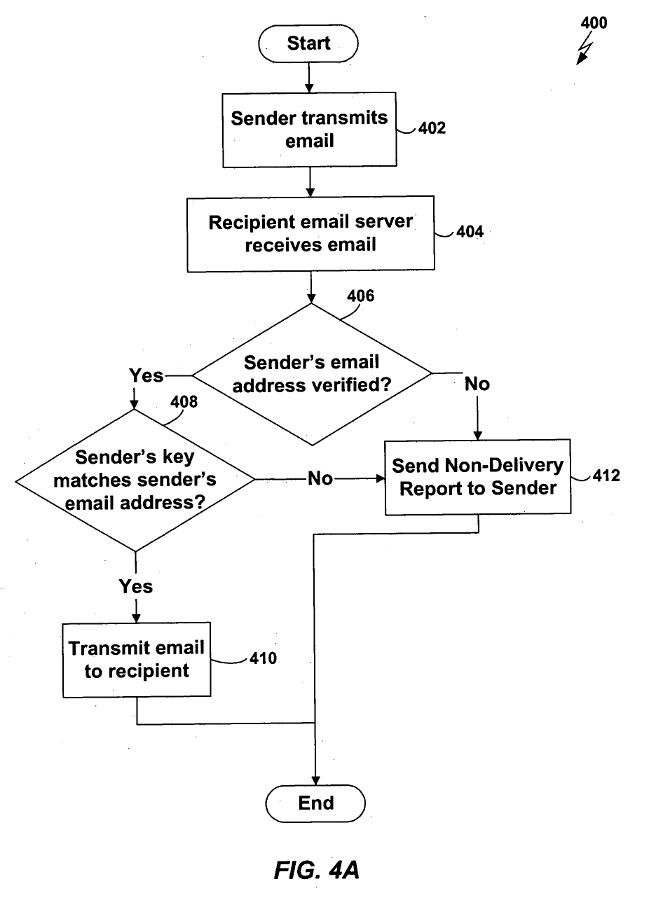

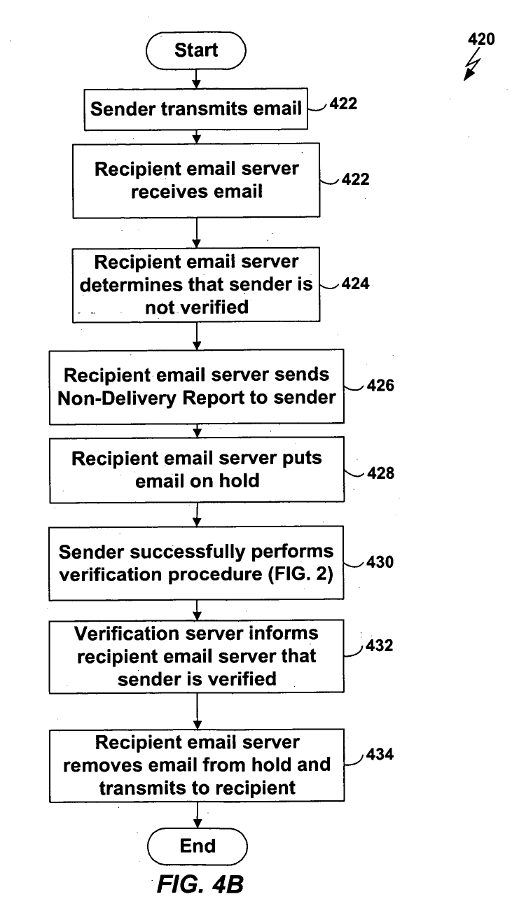

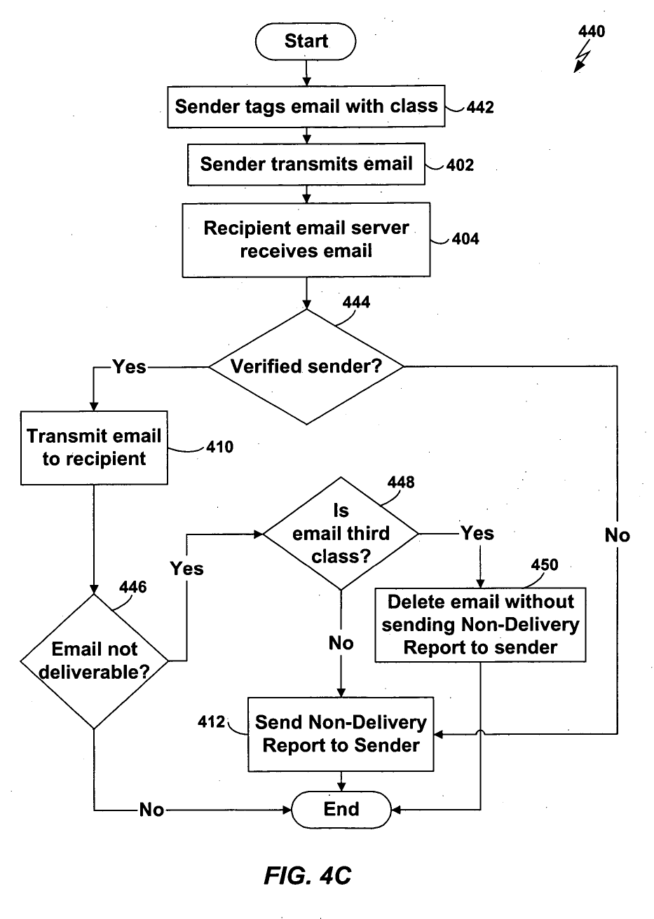

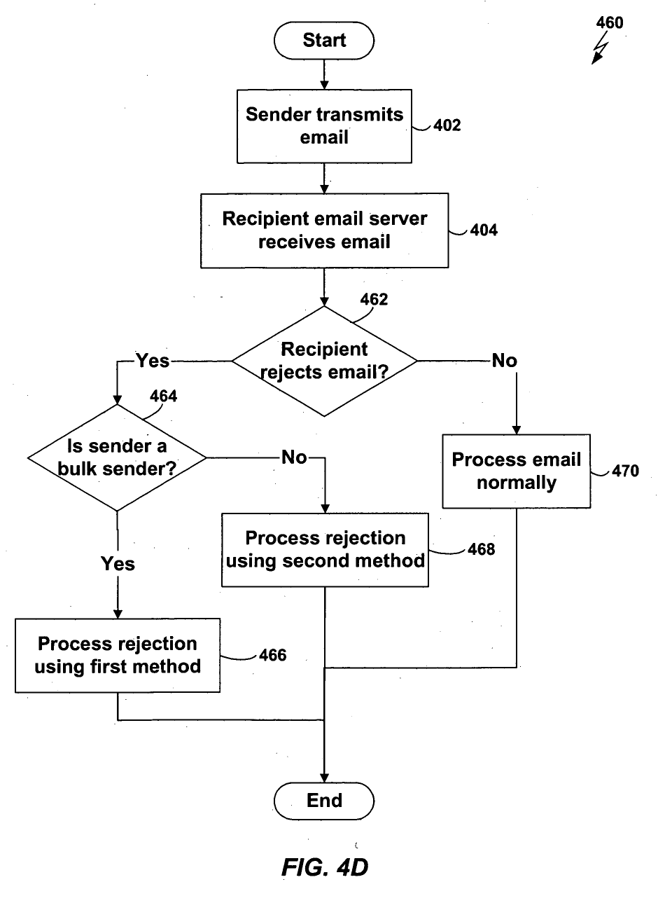

Once the database 114 of verified sender email addresses has been created, it may be used to block or otherwise perform special handling of email transmitted from email addresses that are not in the database 114. Referring to FIG. 3, a dataflow diagram is shown of a system 300 that is used to perform such email processing according to one embodiment of the present invention. Referring to FIG. 4A, a flowchart is shown of a method 400 that is performed by the system 300 of FIG. 3 when a sender 302 of email attempts to transmit an email message.

The sender 302 uses an SMTP client 304 to transmit an email 306 using an SMTP server 307 (step 402). The client 304 may be any SMTP client, such as Microsoft® Outlook® or Qualcomm® Eudora®. Note that the sender 302 may be any kind of sender, such as an individual person transmitting individual email or a software program transmitting bulk commercial email.

When the email 306 is received by the incoming (e.g., POP3) email server 308 for the destination email address 328 specified in the email 306 (step 404), the recipient server 308 determines whether the email address 324 of the sender 302 is in the database 114 (step 406). The recipient server 308 may make this determination by, for example, extracting the email address 324 of the sender 302 from the email 306 and querying 310 the database 114 with the extracted email address 324. The verification server 112 handles the query 310 by searching the database 114 for the sender's email address 324 and sends a response 312 to the recipient server 308 indicating whether the sender's email address 324 was found in the database 114.

Recall that it was stated above that each verified sender may have an associated key that may be used to provide an additional layer of sender verification. The system may, for example, require each verified sender to attach its key 120 to each email it transmits. For example, in FIG. 3, the email 306 transmitted by sender 302 includes a key 326. If the verification server 112 determines that the sender's email address 324 is a verified address, the verification server 112 may further determine whether the email 306 includes a key that corresponds to the verified email address 324 (step 408). If the email 306 does not include any key, or includes a key that does not match the email address 324, the server 112 indicates in the response 312 that the sender 302 is not verified. If, however, the key 326 matches the key indicated by the database 114 as matching the email address 324 of the sender 302, then the server 112 indicates in the response 312 that the sender 302 is verified.

Returning to FIG. 1, once the sender 102 obtains the key 120, the key 120 may be attached to an email in any of a variety of ways. For example, the sender 102 may include the key 120 in the subject line of an email such that the key 120 may be automatically extracted by the recipient server 308. For example, the key 120 may be embedded in a special tag in the subject line. If, for example, the key is “JOHNSKEY”, the key 120 may be embedded in the subject line “Welcome back” as follows: “Welcome back <verificationkey>JOHNSKEY</verificationkey>.” Alternatively, for example, the key 120 may be embedded in one or more headers of the email. The sender 102 may embed the key 120 in the email manually or using software. Furthermore, the SMTP protocol may be modified to require the key 120 to be included in an email before the message is accepted for transmission to the recipient, thereby decreasing the number of NDRs that are generated. These are merely examples of techniques that may be used to embed the key 120 in an email and do not constitute limitations of the present invention.

The benefits of the key 120 stem from the ease with which the email address of the sender 102 may be “spoofed”—hijacked by someone else and used to send email that appears to originate from the sender 102. Spoofing is relatively easy because spammers may harvest email addresses from a wide variety of public sources, such as email messages and web sites, and by hacking into private sources, such as customer databases. The requirement that the key 120 be embedded in any email transmitted by the sender 102 provides an additional layer of security because the key 120 will not be available for harvesting from web sites, from email messages transmitted to the sender 102, or from private sources such as customer databases. Although it is possible for spammers to subvert this system by obtaining keys and using them surreptitiously, the use of keys increases the cost to spammers and therefore acts as a deterrent.

If a change is made or attempted to be made to the key in one of the records 116a-c in the database 114, the verification server 112 may send a confirmatory email to the sender 102 to verify that the change was in fact made intentionally by the sender 102 and not maliciously by a spammer or other third party. If the sender 102 disapproves of the change, the server 112 may keep the old key.

The key 120 may also be used for related purposes, such as to limit unauthorized bulk emailing. The verification server 112 may, for example, keep track of the number of emails that the sender 102 has sent during a particular period of time. If the number exceeds a predetermined threshold (e.g., more than 500 emails in a day), the verification server 112 may change the sender's key. As a result, additional emails that the sender 102 attempts to send will not be transmitted to the designated recipients either until such recipients specifically approve of such emails or until the sender 102 changes its key 120. Although the sender 102 may continue to send additional bulk emails after incorporating the new key into them, this requirement significantly increases the cost to the sender 102 of sending large numbers of emails.

Returning to FIG. 3, note that the database 114 and server 112 may represent a large distributed database system that is available for querying not only by the recipient server 308 but by many distinct recipient servers servicing many sets of recipients. The database 114, in other words, may represent a centralized database that is available for use by any recipient server that services any email recipient. For performance and other reasons, the database 114 may be replicated and distributed using any of a variety of well-known techniques.

Returning to FIG. 4A, if the sender's email address 324 is a verified address (step 406), and the key 326 in the email 306 matches the key specified in the database 114 for the email address 324 (step 408), the recipient server 308 transmits the email 306 to the email client 314 of the designated recipient 316 (step 410), thereby successfully completing transmission of the email 306. If the sender's email address 324 is not a verified address, the recipient server 308 may take any of a variety of actions. For example, the recipient server 308 may transmit a Non-Delivery. Report 318 to the sender 302 using the sender's email address that was extracted from the email 306 (step 412). Although not shown in FIG. 3 for ease of illustration, the sender server 308 forwards the NDR 318 to the sender client 304.

The NDR 318 may, for example, include a link to a web site associated with the verification server 112 or other means that may be used by the sender 302 to register its email address with the database 114. Alternatively, for example, the recipient server 308 may simply delete the email 306.

The embodiment illustrated in FIGS. 3 and 4 requires the recipient server 308 to have access to and the ability to query the database 114. Such access and ability may be provided in any of a variety of ways. For example, if the database 114 is maintained by a distinct company from that which manages the recipient server 308, access to the database 114 may be provided through a contractual agreement that requires payment of licensing fees, such as a registration fee. The amount of payment may additionally or alternatively be based on the number of queries made by the recipient server 308 to the database 114.

Although in the method 300 illustrated in FIG. 4A, the recipient server 308 transmits an NDR 318 if the sender 302 is not a verified sender or if the sender 302 does not provide a matching key, this is merely one example of an action that may be taken in such a case. For example, in addition to or instead of sending an NDR, the recipient server 308 may place the email 306 on “hold” 318 if the sender 302 is not a verified sender or if the sender 302 does not provide a matching key.

More generally, the recipient server 308 may use any criteria to determine whether to place incoming email into the holding area 318. The holding area 318 represents any form of temporary storage in which emails may be stored pending further processing. For example, in one embodiment of the present invention, the recipient server 308 sorts all incoming email into categories in the holding area 318 such as “possible good email,” “likely spam,” and “possible desirable bulk email.” Emails may be stored in the holding area 318 in these categories rather than being immediately transmitted to the recipient 316.

The recipient server 308 may use any criteria to sort email into categories. For example, emails may be identified as “possible good email” if they are not in the database 114 and the NDR 318 was successfully delivered (i.e., if the sender 302 exists). Emails that are from non-verified senders where the resulting NDR 318 could not be delivered may be identified as “likely spam.” Emails that include indications that they from bulk emailers may be identified as “possible desirable bulk email.” These are merely examples of categories and category sorting techniques that may be used by embodiments of the present invention.

One benefit of the pre-classification procedure just described is that it gives the recipient 316 an indication of how much attention he should pay to each email in the holding area 318. For example, the recipient 316 may choose to always review emails categorized as “possible good email” and always to delete email categorized as “likely spam.” This may save the recipient 316 a significant amount of time compared to a system in which all incoming emails are presented to the recipient 316 in a single, undifferentiated, list.

Emails may be released from hold 318 upon the satisfaction of any of a variety of conditions. For example, upon receiving the NDR 318, the sender 302 may engage in the verification process shown and described above with respect to FIGS. 1 and 2. If the sender 302 successfully completes the verification process and thereby adds its email address to the database 114, the recipient server 308 (upon receiving notification from the verification server 112 that the email-address of the sender 302 has been added to the database 114) may remove the email 306 from hold 318 and forward the email 306 to the designated recipient 316 without any further action required by the recipient 316. This eliminates the need for the sender 302 to manually resend the email 306.

The special case just described is particularly useful as a kind of challenge/response mechanism and is illustrated by the method 420 illustrated in FIG. 4B. To reiterate, the sender 302 transmits the email 306 (step 422). Assume for purposes of example that the sender 302 is not a verified sender, i.e., that there is no record for the sender 302 in the database 114. As a result, when the recipient email server 308 receives the email 306 (step 422), the server 308 determines that the sender 302 is not a verified sender (step 424). As a result, the recipient email server 308 sends the NDR 318 to the sender 302 (step 426) and puts the email 306 on hold 318 (step 428).

In addition to or instead of sending the NDR 318, the recipient email server 308 may send a separate message informing the sender 302 that the email 306 has been put on hold and providing the sender 302 with instructions for performing the verification procedure illustrated in FIGS. 1 and 2. For example, the recipient server 308 may transmit to the sender 302 an email describing the verification procedure and providing a link to a web site where the verification procedure may be performed.

Assume that the sender 302 successfully performs the verification procedure (step 430). The verification server 112 informs the recipient email server 308 that the sender 302 is now verified (step 432), and the recipient email server 308 removes the email 306 from hold 318 and transmits it to the recipient 316 (step 434).

Email recipients may provide various forms of feedback on emails that they have received and/or that are stored in the holding area 318. Such feedback may, for example: (1) be provided to the verification server 112 for use in modifying the contents of the verified sender database 114 (e.g., by adding/removing sender email addresses to/from the database 114); and/or (2) be used to maintain personalized whitelists (lists of approved sender addresses) and/or blacklists (lists of disapproved sender addresses) for individual recipients. Examples of various kinds of feedback that may be provided, and examples of ways in which such feedback may be processed, will now be described.

Once emails have been stored in the holding area 318, the recipient 316 may review the emails in the holding area 318 and take action on them. For example, the recipient 316 may choose to object to the email 306, in response to which the recipient server 308 may delete the email 306 from the holding area 318 without transmitting an NDR and add the email address 324 of the sender 302 to a personalized blacklist of the recipient 316. The recipient 316 may indicate that the sender 302 of the email 306 is a person or other legitimate sender, in response to which the recipient server 308 may remove the email 306 from hold 318, transmit it to the recipient 316, and add the email address 324 of the sender 302 to a personalized whitelist of the recipient 316.

For example, upon placing the email 306 on hold 318, the recipient server 308 may transmit an approval query 320 to the recipient 316, informing the recipient 316 that the email 306 has been put on hold 318 and is addressed to the recipient 316. The recipient 316 may provide a response 322 indicating whether the recipient 316 approves of the sender 302. If the recipient 316 approves of the sender 302, the recipient server 308 may remove the email 306 from hold 318, transmit the email 306 to the recipient 316, and add the email address 324 of the sender 302 to the recipient's whitelist. If the recipient 316 does not approve of the sender 302, the recipient server 308 may perform any of the actions described above, such as sending an NDR 318 to the sender 302 and/or deleting the email 306.

More generally, the recipient 316 may review the emails in the holding area 318 and take any of a variety of actions on them. For example, the recipient 316 may override the categories into which the recipient server 308 has placed the emails in the holding area 318. If, for example, the recipient server 308 has labeled the email 306 as “probable legitimate email,” the recipient 316 may label the email 306 as “spam,” thereby causing the recipient server 308 to take the actions described above for emails sent by unverified senders.

Note that although the holding area 318 may be a convenient mechanism for controlling the flow of potentially unwanted emails into the inbox of the recipient 316, the holding area 318 is not required. For example, the recipient server 308 may transmit all email from verified senders with matching keys to the recipient 316. The recipient 316 may then use the email client 314 or other software to perform any of the actions described above, such as recategorizing emails, once the emails are in the recipient's inbox.

Note further that actions taken by the recipient 316, and by other recipients, may be provided as feedback to the verification server 112. For example, if the recipient 316 forwards an email to a special email address (e.g., iobject∩itsspam.com) or marks a specific email as spam or otherwise as undesirable, this information may be provided to the verification server 112. In response, the verification server 112 may take an appropriate action, such as removing the email address of the email's sender from the database 114 or changing the sender's key, thereby requiring the sender to re-register with the system before becoming able to send additional emails.

More generally, any form of “collaborative filtering” may be employed to use the feedback provided by users of the system 300 to update the contents of the verified sender database 114 and thereby to improve the filtering capabilities of the system 300. For example, the verification server 112 may not immediately add a sender to the verified sender database 114 when a single recipient approves of the sender. Rather, the verification server 112 may add the sender to the database 114 only upon receiving approval of the sender from a sufficient number of recipients. This feature may, for example, be useful for collaboratively verifying legitimate bulk senders. Similarly, the verification server 112 may remove a sender from the database 114 (or change the classification of a sender from “individual” to “bulk sender”) only upon receiving disapproval of the sender from a sufficient number of recipients.

As an alternative to removing a sender's email address from the database 114, the sender's key may be changed and the sender notified that the key has been changed due to improper or unauthorized use (e.g., spoofing). The database may also maintain statistics about each sender, such as the ratios of the sender's emails that have been sent, released, accepted, and rejected, and use these statistics to determine if email sent by the sender should be held or released based on recipients' desires.

Furthermore, an administrator of the database 114 may manually add, remove, or modify the contents of the database 114. This feature may be useful, for example, for enabling known legitimate bulk email senders to send bulk email without requiring such senders to explicitly perform the verification procedure.

As mentioned above, spammers benefit from the relatively low gain of the negative feedback loop for transmitting spam. A good spam control system will not prevent all bulk emailing, but rather will provide deterrents for undesirable behavior.

It may be desirable to distinguish between senders of individual emails and senders of bulk email because it may be desirable to permit legitimate bulk senders to send large numbers of emails while still prohibiting other senders from doing so. One way to implement this distinction is to require individual senders—those individuals who indicate their intention to send relatively small numbers of individual emails at a time—to register only their email addresses and corresponding keys in the database 114, while requiring bulk email senders—those senders who indicate their intention to send bulk email—to register additional information, such as their IP addresses. Each record in the database 114, therefore, may include a sender email address and key, an indication of the type of sender (e.g., individual or bulk emailer), and an IP address of the sender if the sender is a bulk email sender.

If a sender who has not registered as a bulk emailer attempts to send bulk email, the verification server 112 may prevent such emails from being transmitted. The verification server 112 may, for example, keep a count of the number of emails transmitted by each sender and prohibit non-bulk emailers from transmitting more than a predetermined threshold of emails (e.g., 500/day). In contrast, the verification server 112 may allow registered bulk emailers to send an unlimited number of emails, provided that such emails are transmitted from the IP address that is registered for the bulk emailer. The server 112 may reject emails transmitted from a verified bulk email address even if they contain the right key if they are not transmitted from the registered IP address. This mechanism allows legitimate bulk emailers to conduct business while providing an additional layer of protection against fraud.

The preceding description should make clear that the sender's IP address is one example of a criterion—in addition to a verified email address and matching key—that may be required for a sender to qualify as “verified.” Furthermore, even emails from “verified” senders may not be transmitted to their recipients under certain circumstances. For example, a bulk sender may by default may by default be added to the database 114 as a “verified” but “undesired” sender upon satisfying the verification conditions 122. The verification server 112 may keep track of the “verified” and “desired” status of senders, and provide that information to the recipient server 308 upon request. The recipient server 308 may require that a sender qualify as both “verified” and “desired” before transmitting email from the sender to recipients.

The status of the bulk sender may be changed from “undesired” to “desired” if, for example, a sufficient number of recipients approve of emails sent by the bulk emailer. Conversely, the status of the bulk sender may be changed from “desired” to “undesired” if, for example, a sufficient number of recipients disapprove of emails sent by the bulk sender.

It should be appreciated, therefore, that references herein to “removing” a sender from the database 114 may, for example, be implemented as changing the status of the sender from “desired” to “undesired” and/or from “verified” to unverified. Conversely, references herein to “adding” a sender to the database 114 may, for example, be implemented by adding the sender's email address to the database 114, by changing the status of the sender from “unverified” to “verified,” by changing the status of the sender from “undesired” to “desired,” or any combination thereof.

Bulk senders may register in any of the ways described above for individual senders. For example, they may register by affirmatively contacting the server 112 (e.g., by visiting a web site specifically designed to register bulk senders) or by taking an action in response to an email transmitted by the server 112 to the bulk sender when the bulk sender attempts to transmit email to a recipient who is a user of an email server that uses the verification server 112.

Furthermore, as described above, a bulk sender may be added to the database 114 as a result of a collaborative process in which multiple recipients of email designate the sender as a bulk sender, either directly or indirectly. Recipients may directly designate a sender as a bulk sender by, for example, specifically marking emails sent by the sender as bulk emails when releasing to their inbox. This action may be reported to the database administrator who has the ability to add the sender to the database as a participating bulk mailer. Recipients may indirectly designate a sender as a bulk sender by, for example, objecting to or deleting emails sent by the sender. The verification server 112 may use any decision procedure to determine whether to designate a sender as a verified bulk sender based on the behavior of recipients in response to emails sent by the sender. In the simplest case, a sender may be designated as a verified bulk sender if the sender performs the verification procedure described above with respect to FIGS. 1 and 2, and as a desired bulk sender if more than a predetermined threshold number of recipients designate the sender's emails as bulk emails.

A bulk email sender may be required to pay a fee to register with the verification server 112. The fee may, for example, be determined based on the number of emails sent by the bulk sender and include a prepaid amount for return/complaint handling.

Other techniques may be used in to process bulk email. For example, bulk senders may be required or allowed to include tags, such as “ADV” (for advertisements), “XXX” (for adult material), “AUTO” (for automatically-generated responses), “NWSLTR:” (for newsletters), or “LIST” (for email lists) in the subject line of bulk emails that they transmit. In addition, the verification server 112 may add the tag if if the tag is required and missing.

One or more such tags may be interpreted as indicating that the corresponding email message is a “first class” email, while one or more other tags may be interpreted as indicating that the corresponding email message is a “third class” email. For example, the absence of a tag may be interpreted as a “first class” tag, while “ADV” and “XXX” may be interpreted as “third class” tags. Such interpretation may be performed, for example, by the verification server 112 and/or the recipient server 308. First class emails may be processed differently than third class emails in a way that is analogous to processing of first and third class mail by the U.S. Postal Service. More specifically, NDRs may be transmitted to senders of undeliverable first class email, while undeliverable third class email may be deleted (e.g., by the recipient server 308) without triggering the transmission of an NDR.

Referring to FIG. 4C, for example, a flowchart is shown of a method 440 that is similar to the method 400 shown in FIG. 4A, except that it employs the use of first-class and third-class tags. The sender 302 includes in the email 306 a tag (not shown) indicating whether the email 306 is a first-class or third-class email (step 442). The tag may be included in the email 306 in any way, such as by including the tag in the subject line, header, or any other portion of the email 306.

The method 440 then proceeds in the same manner as the method 400 shown in FIG. 4A, namely by the sender 302 transmitting the email 306 (step 402) and the recipient server 308 receiving the email 306 (step 404) and determining whether the sender 302 is a verified sender (step 444). Step 406 may, for example, be performed by determining whether the sender's address 324, key 326, and (in the case of bulk senders) IP address match the information in the database 114. If the sender 302 is a verified sender, the recipient email server 308 attempts to transmit the email 306 to the recipient 316 (step 410). If the sender 302 is not a verified sender, the recipient email server 308 does not attempt to transmit the email 306 to the recipient 316.

If the recipient server 308 attempts to send the email 306 to the recipient 316 and for any reason the email 306 is undeliverable (step 446), the method 440 determines whether the email 306 is a third-class email (step 448). The method 440 may make this determination, for example, by reference to the tag stored by the sender in step 442.

If the email 306 is a third-class email, the recipient server 308 deletes the email 306 or takes other appropriate action without sending a non-delivery report to the sender 302 (step 450). Eliminating the need to transmit an NDR for bulk emails both reduces the cost imposed on the recipient server 308, on the network more generally, and on the sender 302 (because the sender 302 need not receive and process NDRs for undeliverable emails). If the email 306 is not a third-class email, the recipient server 3.08 transmits non-delivery report 318 to the sender 302 (step 412).

If a bulk email sender sends undesired email, negative feedback may be provided to bulk email sender in a variety of ways. For example, if the recipient 316 indicates that he rejects an email transmitted by a bulk email sender (or any sender) for any reason, the sender may be charged a return fee.

The recipient 316 may indicate rejection of an email message in any of a variety of ways. For example, the recipient's email client 314, or a plugin to such a client, may provide a button or other input mechanism for the recipient 316 to use to reject the email 306. Alternatively, for example, the server 112 may provide a web-based system to which the recipient 316 may log in to view emails that are on hold 318, and through which the recipient 316 may reject or otherwise provide feedback on pending emails. As yet another example alternative, the recipient 316 may forward rejected emails to a special email address, such as iobject@itsspam.com, that provides the rejected emails to the server 112 for processing.

Mechanisms other than monetary penalties may be used to limit abuses by bulk email senders. For example, if the bulk email sender exhibits an excessive degree of offensiveness, as may be indicated by an excessive amount of return fees or when a certain percentage of emails transmitted by the bulk sender have been rejected, the verification server 112 may dynamically reduce the sender's acceptance rating, thereby increasing the number of messages being held requiring recipient action before delivery to the inbox.

Since there is a delay between delivery and recipient feedback (hysteresis), the verification sever 112 may transmit a warning notice to the bulk sender and begin automatically putting all subsequent emails from the bulk sender on hold (e.g., for several days), thereby allowing all potential recipients to read and act upon (e.g., reject) emails transmitted by the offending bulk sender. This would allow the sender to specify ahead of time the maximum amount of rejections in the case of monetary penalties or, in the case of reputation-based penalties, prevent senders from gaming the system. Tools may be provided to the bulk sender to minimize the experienced return rates for their type of business. Such tools may be priced at an amount that is appropriate for the expected savings.

It may be desirable to treat rejection of email sent by individuals differently than rejection of email sent by bulk senders. For example, referring to FIG. 4D, a flowchart is shown of a method 460 that is performed in one embodiment of the present invention to process feedback by a recipient (or potential recipient) of email. As in the case of FIG. 4A, the sender 302 transmits an email 306 (step 402) and the recipient server 308 receives the email 306 (step 404). The recipient server 308 determines whether the recipient rejects the email 306 or otherwise designates the email as bulk email (step 462). Note that step 462 may be performed before or after determining whether the sender 302 is a verified sender.

If the recipient 316 does not reject the email 306, the recipient server 308 processes the email 306 using any of the techniques disclosed herein (step 470), such as determining whether the sender 302 is a verified sender and only transmitting the email 306 to the recipient 316 if the sender 302 is a verified sender.

If, however, the recipient 316 rejects the email 306, the recipient server 308 determines whether the sender 302 is a bulk sender (step 464). The recipient server 308 may, for example, make this determination by determining whether the email address 324 of the sender 302 is registered as the email address of a bulk sender in the database 114. If the sender 302 is a bulk sender, the recipient server 308 processes the rejection using a first method (step 466); otherwise the recipient server 308 processes the rejection using a second method (step 468).

The first and second rejection processing methods may be any combination of methods. For example, in one embodiment, according to the first method (which applies to rejection of email from bulk senders) email from bulk emailers is filtered using collaborative filtering. For example, according to the first method, the rejection may be treated as a vote against the sender 302. As a result, the sender 302 is removed from the verified sender database 114 only if a sufficient number of other recipients have objected to email from that sender 302; otherwise, the sender 302 remains in the database 114 even after the recipient 316 objects to the email 306. In contrast, in one embodiment the second method (which applies to rejection of email from individual senders) immediately removes or changes the key for the sender 302 or otherwise renders the sender effectively unverified upon rejection of the email 306 by the recipient 316. This is merely one example of a way in which feedback provided by the recipient 316 may be processed differently for bulk emailers than for individual emailers.

Among the advantages of the invention are one or more of the following. In general, embodiments of the invention disclosed herein reduce or even eliminate the incentive to fabricate bogus email sender addresses, provide a mechanism to prevent the unauthorized use of real email addresses, and increase the feedback loop gain for those emails that are undeliverable or undesirable. As a result, the techniques disclosed herein may be used to effectively combat spam by addressing the fundamental problems with SMTP described above.

In particular, techniques disclosed herein may be used to verify the email addresses of senders and to enable such verified senders to send email messages to any recipients whose email servers make use of the verification server 112. Many previous anti-spam systems, for example, required individual recipients to approve or disapprove of individual senders. Such systems impose a significant burden on recipients, by requiring them to filter through senders, and impose a significant burden on legitimate bulk email senders, by requiring them to receive individualized approval from a large number of senders.

Techniques disclosed herein, in contrast, relieve recipients of the burden of filtering through senders by imposing on senders the burden of obtaining initial authorization. It is appropriate to put this initial burden on senders because it is they who stand to benefit financially from sending bulk commercial email and because the total cost of requiring a sender to obtain a one-time authorization is significantly lower than the cost of requiring millions of recipients to filter out undesired emails from such a sender. Furthermore, the initial burden on the sender, although sufficient to make undesired bulk commercial email costly, is relatively low for legitimate bulk email senders because the authorization procedure need only be performed once so long as the sender plays by the rules.

Such techniques enable the provider of the verification server 112 to provide senders with a guarantee that the email that they send will not be identified by recipient email servers as undesired email. Such a guarantee may be commercially valuable to the sender. It may, therefore, be commercially valuable for the provider of the verification server 112 to provide such a guarantee to verified senders.

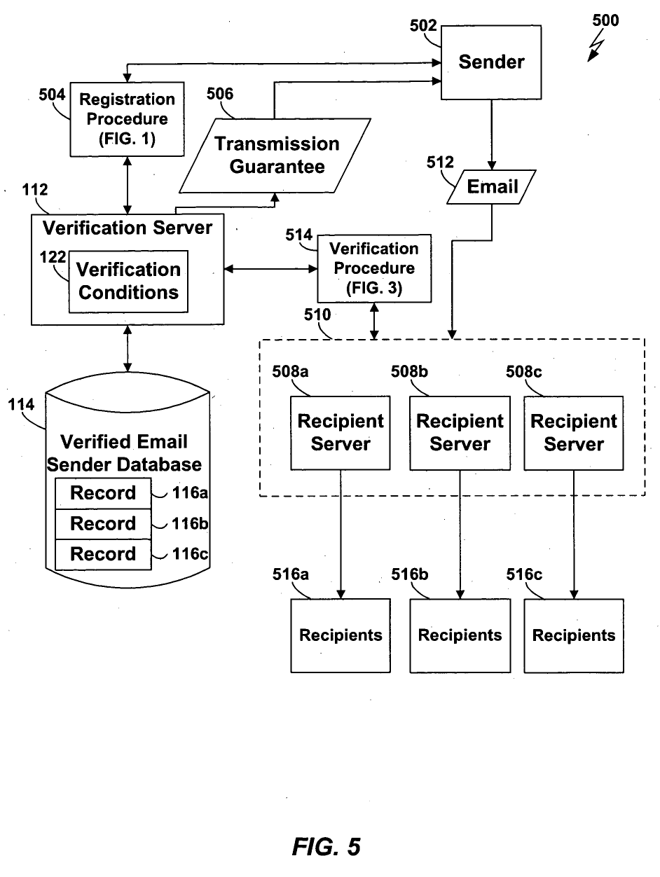

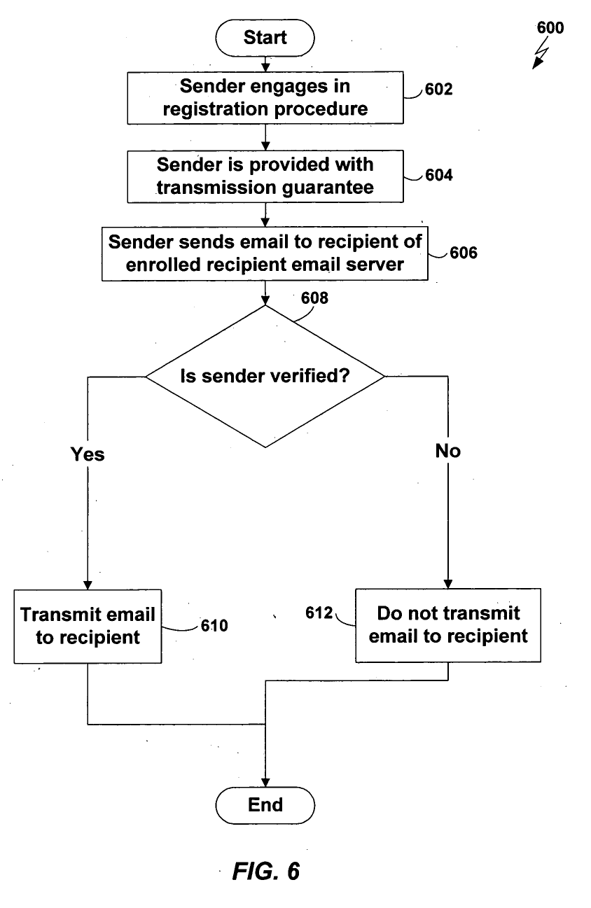

Referring to FIG. 5, for example, a dataflow diagram is shown of a system 500 that is used to provide such a guarantee according to one embodiment of the present invention. Referring to FIG. 6, a flowchart is shown of a method 600 that is performed by the system of FIG. 5 according to one embodiment of the present invention.

A sender 502 engages in the registration procedure 504 described above with respect to FIGS. 1 and 2 (step 602). As a result, the sender 502 is registered in the database 114. For purposes of the present example, it does not matter whether the sender 502 is registered as an individual sender or as a bulk sender of email.

The verification server 112 provides the sender 502 with a transmission guarantee 506 (step 604). Note that the guarantee 506 need not be provided directly by the verification server 112, but rather may be provided by any entity associated with the verification server 112, such as the owner or operator of the verification server 112. Furthermore, the transmission guarantee 506 may be provided in any form, such as an electronic document, electronic report, or a printed contract. The transmission guarantee 506 may be implemented as part of a contractual arrangement between the sender 502, or an entity associated with the sender, and the provider of the guarantee 506. Consideration for the guarantee 506 may, for example, be provided in the form of a fee paid by the sender 502.

For purposes of example, three recipient servers 508a-c that make use of the verification services of the verification server 112 are shown in FIG. 5. It should be appreciated, however, that any number of recipient servers 508a-c may make use of the verification server 112. The guarantee 506 is a guarantee that the email that the sender 502 sends will be delivered to recipients who allow emails from desired bulk emailers. Bulk senders may be classified as “desired” if, for example, they meet a required minimum number of released emails, maintain fewer than a maximum threshold of rejected emails, maintain greater than a minimum threshold of accepted emails, or any combination thereof. Recipient servers that are configured to use the verification server 112 to filter email are referred to herein as the “protected recipients.” Note, however, that email clients (not shown) or other software may also make use of the verification server's services, and that the term “protected recipients” may therefore include not only servers but also clients and other hardware and/or software.

Note that the recipients 516a-c may make use of additional client-side spam-filtering software, or other software for processing email (not shown). The guarantee 506 does not guarantee that such software will not identify email transmitted by the sender 502 as undesired email. Rather, the guarantee 506 only guarantees that the server 508a-c, or any other processing element that uses the verification server 112 (such as email clients that use the verification server's services) will not identify email transmitted by the sender 502 as undesired email.

Recipients 516a-c represent all of the recipients who use recipient servers 508a-c, respectively, as their incoming email servers. The sender 502 transmits an email 512 to one of the recipients 516a-c (step 606). The corresponding one of the recipient servers 508a-c performs any of the verification procedures 514 described above with respect to FIGS. 3-4 to determine whether the sender 502 is verified (step 608). Note that for purposes of the present discussion, the sender 502 is “verified” if it satisfies all of the applicable requirements for verification (e.g., an email address, key, and IP address (in the case of bulk mailers) that match a corresponding record in the database 114).

If the sender 502 is verified, the recipient server transmits the email 512 to the corresponding one of the recipients 516a-c (step 610), thereby satisfying the guarantee 506 previously provided to the sender 502. If, however, the sender 502 is not verified (e.g., if the sender 502 did not provide the correct key or send the email 512 from the correct IP address), the email 512 is not transmitted to the recipient (step 612). It should be clear based on this description that although the guarantee 506 does not guarantee that the protected servers 510 will transmit each email from the sender 502 to the corresponding recipient 516a-c, it does guarantee that such emails will be transmitted to their recipients if the sender 502 follows the rules established by the verification server 112.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Although certain functions may be described herein as being performed by “clients” and “servers,” the techniques herein are not limited to use with client-server architectures. Rather,, the techniques disclosed herein may be implemented using any appropriate means. As a result, functions that are described herein as being performed by “clients” may be performed by servers or other elements, and functions that are described herein as being performed by “servers” may be performed by clients or other elements.

In particular, the functions described herein as being performed by the verification server 112 may be performed by any means, and may be subdivided among multiple components. For example, the functions of the verification server 112 may be performed by a combination of a database server, captcha server, and credential authentication server. Functions disclosed herein as being performed by the recipient server 308 may alternatively be performed by an email client or other means.

Although certain techniques disclosed herein attempt to determine whether a particular sender is a person, it is never possible to make such a determination with complete certainty. It is always possible, particularly with improvements in technology, for a machine to pass a test that is designed for only humans to pass. Therefore, the techniques disclosed herein should be interpreted to impose conditions that are treated as sufficient evidence that the sender is a person, and to treat those senders that satisfy the conditions as people, even if it cannot be known with certainty that such senders actually are people.

Although terms such as “spam” and “unsolicited email” may be used herein, the techniques disclosed herein are not limited to use in conjunction with these particular kinds of email. Rather, the techniques disclosed herein may be used in conjunction with any kind of email. It may, for example, be desirable to block the transmission of email transmitted by particular senders even if such email is non-commercial in nature or has been solicited. The techniques disclosed herein may be used to block the transmission of such email.

Even more generally, the techniques disclosed herein are not limited to use in conjunction with email. Rather, the same or similar techniques may be used in conjunction with instant messages, text messages, or any other kind of electronic communication.

Similarly, although references are made herein to SMTP, the techniques disclosed herein are not limited to use in conjunction with SMTP, but rather may be used in conjunction with any electronic communications protocol.

Although certain data elements, such as the sender key 326, sender IP address, and tags may be described herein as being stored in certain portions of an email message (such as the subject line or headers), this is not a requirement of the present invention. Rather, any such data element may be stored anywhere, such as in any portion of an email and/or in data accompanying or otherwise associated with the email and/or sender of the email.

The techniques disclosed herein may be combined with any other techniques for blocking spam or otherwise controlling the transmission of email, such as blacklists, whitelists, and collaborative filtering.

Although the set of verified email addresses is described herein as being stored in a “database” 114, such information may be stored in a data structure or system other than a “database.” Furthermore, such a database or other data structure may be distributed, replicated, or otherwise stored and accessed using any appropriate techniques.

Furthermore, although the database 114 is referred to herein as a database of “verified” email addresses, the database 114 may also contain unverified email addresses. The database 114 may, for example, include both verified and unverified email addresses and include an indication of whether each email address is verified or unverified. Furthermore, for verified email addresses, the database 114 may store an indication of whether email sent from that email address is desired or undesired by recipients.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) determining whether information received over a network from a first sender satisfies predetermined conditions indicating that the first sender is a person; and
(B) if the received information satisfies the predetermined conditions, adding an email address of the first sender to a set of email addresses for which the predetermined conditions have been satisfied.

2. The method of claim 1, wherein (B) comprises adding the email address of the first sender to a set of email addresses from which email is approved to be sent through a predetermined set of email servers.

3. The method of claim 1, further comprising:
(C) prior to (A), transmitting a prompt to the first sender over the network; and
wherein the received information comprises information transmitted by the first sender in response to the prompt.

4. The method of claim 3, wherein (B) comprises determining that the received information satisfies the predetermined conditions if the received information matches a predetermined response to the prompt.

5. The method of claim 3, wherein the prompt comprises a captcha.

6. The method of claim 1, further comprising:
(C) after (B), receiving an email from a second sender;
(D) identifying an email address of the second sender;
(E) identifying a destination email address of the email; and
(F) transmitting the email to the destination email address only if the email address of the second sender is in the set of email addresses for which the predetermined conditions have been satisfied.

7. The method of claim 6, further comprising:
(G) if the email address of the second sender is not in the set of email addresses for which the predetermined conditions have been satisfied, transmitting a Non-Delivery Report to the email address of the second sender.

8. The method of claim 6, wherein the first sender is the same as the second sender.

9. The method of claim 6, further comprising:
(G) prior to (F), identifying a key associated with the email; and
wherein (F) comprises transmitting the email to the destination email address if the email address of the second sender is in the set of email addresses for which the predetermined conditions have been satisfied and the key matches a predetermined key associated with the second sender.

10. The method of claim 1, further comprising:
(C) prior to (A), receiving the information over the network from the first sender.

11. A computer-implemented method comprising:
(A) adding an email address of a first sender to a list;
(B) adding to the list a first key corresponding to the first sender;
(C) adding an email address of a second sender to the list;
(D) adding to the list a second key corresponding to the second sender; and
(E) inserting the first key into an email originating from the first sender.

12. The method of claim 11, wherein the second key differs from the first key.

13. A computer-implemented method comprising:
(A) receiving an email from a sender over a computer network;
(B) identifying an email address of the sender;
(C) identifying a destination email address of the email; and
(D) transmitting the email to the destination email address only if the email address of the sender is in a set of verified email senders who have satisfied predetermined conditions indicating that the verified email senders in the set are people.

14. The method of claim 13, further comprising:
(E) if the email address of the sender is not in the set of verified email senders, transmitting a Non-Delivery Report to the email address of the sender.

15. A computer-implemented method comprising:
(A) attempting to extract from an email message a sender email address and a key associated with the sender email address; and
(B) transmitting the email message to a specified recipient of the email message only if the sender email address and key are successfully extracted and the sender email address and key are associated with an email sender.

16. The method of claim 15, wherein (A) comprises attempting to extract the key from a subject of the email message.

17. The method of claim 15, wherein (A) comprises attempting to extract the key from a header of the email message.

18. The method of claim 15, wherein (A) comprises attempting to extract the key from an attachment to the email message.

19. The method of claim 15, wherein (B) comprises:
(B)(1) determining whether the sender email address is a verified sender email address;
(B)(2) determining whether the key is associated with the verified sender email address; and
(B)(3) transmitting the email to the specified recipient only if the sender email address is a verified sender email address and the key is associated with the verified sender email address.

20. The method of claim 15, wherein (B) comprises transmitting the email message to a specified recipient of the email message only if the sender email address and key are successfully extracted and the sender email address and key are associated with an email sender that has satisfied predetermined conditions indicating that the email sender is a person.

21. The method of claim 15, wherein (B) comprises transmitting the email message to a specified recipient of the email message only if the sender email address and key are successfully extracted and the sender email address and key are associated with an email sender that has satisfied predetermined conditions indicating that the email sender is a participating bulk sender.

22. A computer-implemented method comprising:
(A) determining whether a sender email address is a verified sender email address;
(B) determining whether a key is associated with the verified sender email address; and
(C) providing over a network an indication whether the sender email address is a verified sender email address and whether the key is associated with the verified sender email address.

23. The method of claim 22, further comprising:
(D) prior to (A), receiving a request to determine whether the sender email address and key are associated with a verified email sender; and
wherein (A), (B), and (C) are performed in response to (D).

24. A method comprising:
(A) identifying a plurality of email senders as verified and desired email senders;
(B) identifying a plurality of email servers as member email servers, the plurality of email servers having a plurality of email users; and
(C) providing a guarantee to one of the plurality of email senders that the plurality of member email servers will not identify emails transmitted by that email sender to any of the plurality of email users as undesired email.

25. The method of claim 24, wherein (C) comprises providing a guarantee to the one of the plurality of email senders that the plurality of member email servers will not block transmission of emails transmitted by that email sender to any of the plurality of email users as undesired email.

26. The method of claim 24, wherein (A) comprises:
(A)(1) identifying a plurality of email senders as verified and desired email senders, wherein each of the plurality of email senders satisfies at least one of the following criteria: sending at least a predetermined minimum number of emails released by their recipients; sending fewer than a predetermined maximum number of emails rejected by their recipients; and sending greater than a minimum number of emails accepted by their recipients.

27. A computer-implemented method comprising:
(A) providing in an email message a tag specifying whether the email message is of a first class that requires the transmission of a Non-Delivery Report (NDR) upon failure to transmit the email message to its recipient or of a second class that does not require the transmission of an NDR upon failure to transmit the email message to its recipient; and
(B) transmitting the email message over a network.

28. The method of claim 27, further comprising:
(C) in response to identifying that the email message has failed to be transmitted to its recipient, identifying the class specified by the tag; and
(D) transmitting an NDR only if the specified class is the first class.

29. The method of claim 27, wherein (D) comprises:
(D)(1) identifying a sender of the email message; and
(D)(2) transmitting the NDR to the sender.

30. A computer-implemented method comprising:
(A) receiving an email message containing a tag specifying whether the email message is of a first class that requires the transmission of a Non-Delivery Report (NDR) upon failure to transmit the email message to its recipient or of a second class that does not require the transmission of an NDR upon failure to transmit the email message to its recipient;
(B) determining whether the email message has failed to be transmitted to its recipient;
(C) if the email message is determined to have failed to be transmitted to its recipient:
(C)(1) identifying the class specified by the tag; and
(C)(2) transmitting an NDR only if the specified class is the first class.

31. The method of claim 30, wherein (C)(2) comprises:
(C)(2)(a) identifying a sender of the email message; and
(C)(2)(b) transmitting the NDR to the sender.

32. A computer-implemented method comprising:
(A) receiving an email from a sender over a computer network;
(B) receiving feedback about the email from a designated recipient of the email;
(C) determining whether the sender is a bulk sender of email;
(D) if the sender is a bulk sender, processing the feedback using a first method; and
(E) if the sender is not a bulk sender, processing the feedback using a second method that differs from the first method.

33. The method of claim 32, wherein (B) comprises receiving a rejection of the email from the designated recipient, wherein (D) comprises registering a vote against the sender in a database of verified senders of email, and wherein (E) comprises removing an email address of the sender from the database of verified senders of email.

34. A computer-implemented method comprising:
(A) receiving a first email over a computer network, the first email specifying a sender email address;
(B) in response to receiving the first email, sending a message to the sender email address;
(C) determining whether the message is deliverable to the sender email address;
(D) identifying an intended recipient of the first email; and
(E) providing the intended recipient of the first email an indication whether the message is deliverable.

35. The method of claim 34, wherein (B) comprises sending a second email to the sender email address.
